(19) United States
(12) Patent Application Publication
(10) Pub. No.: US 2026/0153854 A1
(43) Pub. Date: Jun. 4, 2026

(54) UNIT OF ONE MANUFACTURING OF A GARMENT

(71) Applicant: Resonance Companies LLC, New York, NY (US)

(72) Inventors: Lawrence Lenihan, New York, NY (US); Christian Gheorghe, New York, NY (US)

(73) Assignee: Resonance Companies LLC, New York, NY (US)

(21) Appl. No.: 18/967,758

(22) Filed: Dec. 4, 2024

(51) Int. Cl. G05B 19/408; G05B 19/18; G06K 7/10

(52) U.S. Cl. CPC G05B 19/4083; G05B 19/188; G06K 7/10445

(57) ABSTRACT

Unit of one manufacturing of a garment includes remote sensing an identity of a fabric component of a garment at a manufacturing apparatus of a garment manufacturing system, retrieving a unique identifier for the remotely sensed identity and transmitting a query to a process management platform with the unique identifier so as to receive in response, a set of manufacturing parameters within a digital artifact for the garment that are specific to the manufacturing apparatus. Unit of one manufacturing of a garment additionally includes configuring the manufacturing apparatus with the manufacturing parameters and operating the manufacturing apparatus upon the fabric component. Finally, unit of one manufacturing includes recording observed metrics of the operation of the manufacturing apparatus and the fabric component and transmitting the observed metrics to the process management platform for use in augmenting the digital artifact.

### BACKGROUND OF THE INVENTION

### Field of the Invention

The present invention relates to the technical field of garment manufacturing and more particularly to the control and parameterization of different garment processing apparatuses in a garment manufacturing assembly line.

### Description of the Related Art

The fashion industry is a major environmental challenge, responsible for approximately ten percent of global carbon emissions and nearly twenty percent of wastewater. Modern clothing production operates on a system of mass production and rapid consumption driven by the fast-fashion model. This has led to significant environmental impacts that demand attention and action.

This approach begins with the extraction and processing of raw materials, where natural fibers such as cotton require vast quantities of water, pesticides, and fertilizers. In contrast, synthetic fibers like polyester, derived from petroleum, contribute to fossil fuel depletion and greenhouse gas emissions. The fibers are then spun into yarns, woven or knitted into fabrics, and subjected to various chemical treatments to achieve desired colors, textures, and finishes. These processes consume significant amounts of energy and water and often involve hazardous chemicals that can harm workers and the environment.

The manufacturing phase of the fashion industry is also resource-intensive. Garment factories operate on a large scale to meet the demands of fast fashion brands that prioritize speed and low cost over sustainability. This results in high volumes of fabric waste, as large batches are cut from standard patterns with little regard for minimizing leftover material. Additionally, the processes of textile dyeing and finishing are particularly problematic, as they introduce toxic substances into water sources, contaminating local ecosystems.

The environmental impact of modern clothing production is profound. The textile dyeing and finishing stages generate pollution that contaminates water sources and ecosystems, while microplastics from synthetic fabrics shed during washing contribute to ocean pollution and pose threats to marine life. The energy-intensive nature of textile production further exacerbates climate change through substantial carbon emissions.

On the social side, the fast fashion model relies heavily on labor in developing countries, where workers often face poor conditions and low wages. The pressure to produce garments quickly and cheaply can lead to exploitative practices, including excessive working hours and unsafe working environments. These human costs are frequently hidden from consumers, who are often unaware of the true price of their inexpensive clothing.

Most shockingly, because of the nature of mass production caused by the fast-fashion model, the resulting production run of a particular garment satisfies the need and desire of only a small segment of the potential market. As a result. the vast majority of garments which are produced en masse for a very short sales cycle, ultimately, are never sold. These unsold garments invariably find themselves in landfills across the globe. Thus, the need for transformative change in the fashion industry is evident, demanding a shift towards sustainable and ethical practices to address its significant environmental and social impacts.

### BRIEF SUMMARY OF THE INVENTION

Embodiments of the present invention address technical deficiencies of the art in respect to garment manufacturing of a single, bespoke garment while persisting an objective conclusion with respect to the produced bespoke garment relative to a specified bespoke garment. To that end, embodiments of the present invention provide for a novel and non-obvious garment manufacturing system adapted for unit of one manufacturing of a garment. Embodiments of the present invention also provide for a novel and non-obvious garment manufacturing method performed by the foregoing garment manufacturing system. Finally, embodiments of the present invention provide for a computing device adapted to perform the foregoing method.

In one embodiment of the invention, a garment manufacturing data processing system is adapted for unit of one manufacturing of a garment. The system includes a manufacturing apparatus processing fabric components of garments as part of a sequence of manufacturing apparatuses of a garment fabrication system which collectively fabricate the garments. The system also includes a host computing platform of one or more computers, each with memory and one or processing units including one or more processing cores. The system further includes a process management platform communicatively coupled to the host computing platform over a data communications network and providing an application programming interface (API) configured to receive through the API unique identifiers and return in response different sets of manufacturing parameters within correspondingly different digital artifacts, each for an associated one of the garments with the manufacturing parameters being specific to a specified one of the manufacturing apparatuses. Finally, the system includes a configuration and performance module.

The module includes computer program instructions enabled while executing in the memory of at least one of the processing units of the host computing platform to remotely sense an identity of one of the fabric components of one of the garments at a selected one of the manufacturing apparatus and to retrieve a unique identifier for the remotely sensed identity. The program instructions then transmit a query to the process management platform with the unique identifier along with an identity of the manufacturing apparatus. In return, the program instructions receive one of the different sets of the manufacturing parameters within the corresponding one of the correspondingly different digital artifacts for the one of the garments that are specific to the manufacturing apparatus. Finally, the program instructions configure the manufacturing apparatus with the manufacturing parameters of the one of the different sets of the manufacturing parameters and operate the manufacturing apparatus upon the one of the fabric components, all the while recording observed metrics of the operation of the manufacturing apparatus and the one of the fabric components and transmitting the observed metrics to the process management platform for use in augmenting the corresponding one of the correspondingly different digital artifacts.

In one aspect of the embodiment, the manufacturing apparatuses includes an ink printer, laser cutter and sewing machine. In another aspect of the embodiment, the identity of the one of the fabric components is remotely sensed visually by comparing a captured visual image of the one of the fabric components to pre-stored imagery of the one of the fabric components as a substrate upon which the one of the fabric components has been printed is loaded into the manufacturing apparatus. In yet another aspect of the embodiment, the identity of the one of the fabric components is remotely sensed by reading a radio frequency identification (RFID) tag fixed to the one of the fabric components. In even yet another aspect of the embodiment, the corresponding one of the correspondingly different digital artifacts is a singular aggregation of data defining physical and economic characteristics both of the one of the garments and also of a manufacturing lifecycle of the one of the garments across all of the manufacturing apparatuses to which the one of the garments is subjected.

In this way, the technical deficiencies of bespoke manufacturing of a garment are overcome owing to the dynamic identification of a fabric component of a garment engaged to be processed by the manufacturing apparatus and the specific configuration of the apparatus based upon the dynamically identified fabric components according to a dynamically updateable digital artifact pertaining to the unit of one manufacture of the garment, and the recording in the dynamically updateable digital artifact of the performance of the operation of the manufacturing apparatus while processing the fabric component as configured. To be sure, the dynamically updateable digital artifact not only determines in real time how the manufacturing apparatus is to be configured in order to process the fabric component in accordance with a bespoke order to fabricate the garment reflected in the artifact, but also the dynamically updateable digital artifact memorializes the outcome of such configuration once the fabric component has been processed by the manufacturing apparatus.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a process of unit of one manufacturing of a garment;

FIG. 2 is a block diagram depicting a garment manufacturing system adapted for unit of one manufacturing of a garment in accordance with the process shown in FIG. 1; and,

FIG. 3 is a flow chart illustrating one of the aspects of the process of unit of one manufacturing of a garment as shown in FIG. 1.

### DETAILED DESCRIPTION OF THE INVENTION

Embodiments of the invention provide for a garment manufacturing system adapted for unit of one manufacturing of a garment. In accordance with an embodiment of the invention, different manufacturing apparatuses combine to process components of a product such as a garment. Each corresponding one of the apparatuses sense an identity of a component subject to processing within the corresponding one of the apparatuses and provide the identity to a process management platform which returns in response a set of manufacturing parameters for the component extracted from a digital artifact for the component and which are to be applied in configuring the corresponding one of the apparatuses. Finally, process observables are collected during the processing of the component and provided to the process management platform for insertion into the digital artifact of the component.

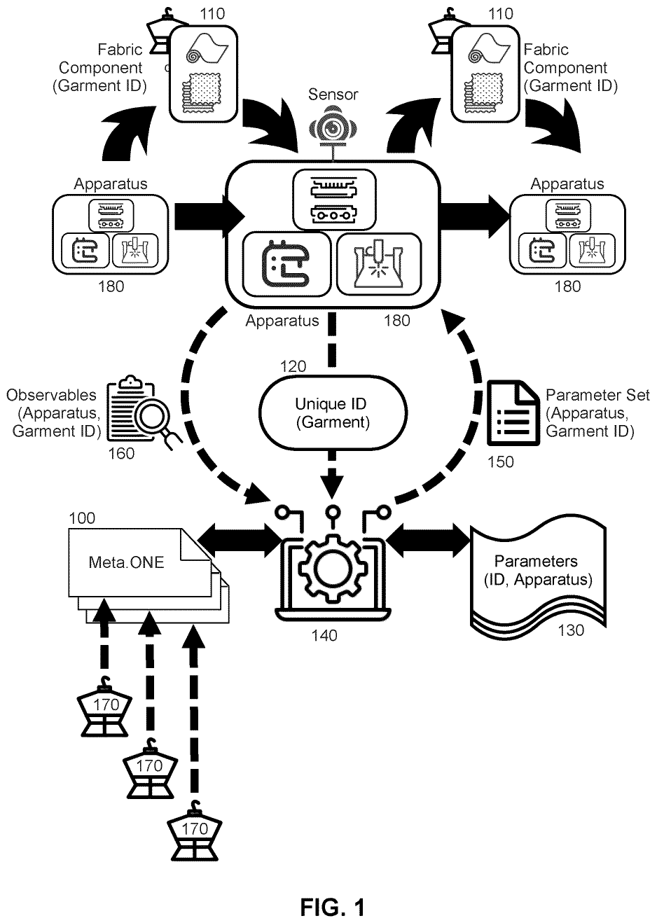

In illustration of one aspect of the embodiment, FIG. 1 pictorially shows a process of unit of one manufacturing of a garment. As shown in FIG. 1, different apparatuses 180 combine to process a fabric component 110 into a garment 170. The apparatuses 180 can include by way of example, an ink printer, laser cutter and sewing machine. As each corresponding one of the apparatuses 180 loads a substrate upon which the fabric component 110 has been printed, a sensor 190 senses an identity 120 of the fabric component 110, for instance by capturing a visual image of the fabric component 110 and comparing the captured visual image to pre-stored imagery of the one of the fabric components or by reading an RFID tag fixed to the fabric component 110.

Thereafter, the identity 120 is provided to a process management platform 140 which in turn retrieves a digital artifact 100 corresponding to the garment 170. The process management platform 140 extracts different manufacturing apparatus parameters 130 from the digital artifact 100 for the garment 170 and returns a parameter set 150 to the corresponding one of the apparatuses 180 to be applied by the corresponding one of the apparatuses 180 in processing the fabric component 110. During the processing of the fabric component 110, the corresponding one of the manufacturing apparatuses 180 captures processing data, e.g. observables 160 in respect to the processing of the fabric component 110 and returns the observables 160 to the process management platform 140. In consequence, the process management platform 140 writes the observables 160 to the digital artifact 100 corresponding to the garment 170 and in connection with the corresponding one of the manufacturing apparatuses 180.

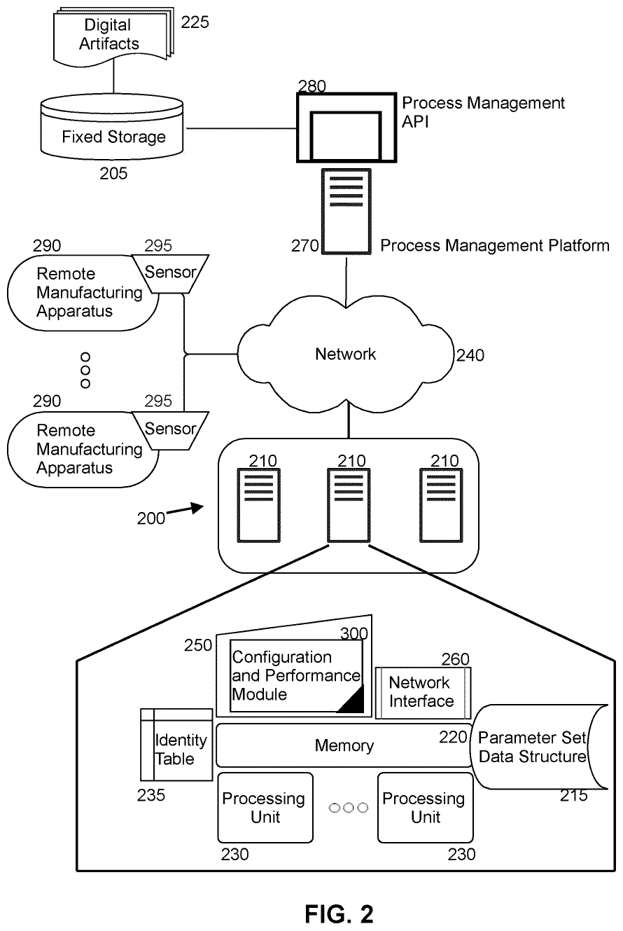

Aspects of the process described in connection with FIG. 1 can be implemented within a data processing system. In further illustration, FIG. 2 schematically shows a data processing system adapted to perform unit of one manufacturing of a garment. In the data processing system illustrated in FIG. 1, a host computing platform 200 is provided. The host computing platform 200 includes one or more computers 210, each with memory 220 and one or more processing units 230. The computers 210 of the host computing platform (only a single computer shown for the purpose of illustrative simplicity) can be co-located within one another and in communication with one another over a local area network, or over a data communications bus, or the computers can be remotely disposed from one another and in communication with one another through network interface 260 over a data communications network 240.

The host computing platform 200 is communicatively coupled over the data communications network 240 to different remote manufacturing apparatuses 290 operating in concert to process fabric components into a specific garment associated with a particular garment identifier. Each of the remote manufacturing apparatuses 290 has included therewith, a sensor 295 adapted to respond to the loading of a substrate incorporating one or more fabric components for respective garments by identifying a particular one of the fabric components on the substrate and mapping the identified fabric component with an associated garment identifier. To that end, the sensor 295 can be an optical barcode reader as one example, or an RFID tag reader as another example, or a camera as yet another example.

The host computing platform 200 accesses a process management API 280 presented by process management platform from over the data communications network 240. The process management API 280 accepts garment identifier queries against a collection of digital artifacts 225 persisted within fixed storage 205, each having an association with a different garment identifier. The process management API 280 additionally accepts directives to write encapsulated observational performance data in respect to a specific garment identifier to one of the digital artifacts 225 associated with the specific garment identifier and a corresponding one of the remote manufacturing apparatuses 290 from which the observational performance data is received.

Notably, a computing device 250 including a non-transitory computer readable storage medium can be included with the data processing system 200 and accessed by the processing units 230 of one or more of the computers 210. The computing device stores 250 thereon or retains therein a program module 300 that includes computer program instructions which when executed by one or more of the processing units 230, performs a programmatically executable process for unit of one manufacturing of a garment. Specifically, the program instructions during execution receive from a sensor 295 of an associated one of the manufacturing apparatuses 290, identification information for a fabric component under process, with which the program instructions map in an identity table 235 in the memory 220 to a garment identifier. The program instructions then render a query encapsulating the garment identifier through the network interface 260 to the process management API and receive, in response, a parameter set 215 for configuring the associated one of the manufacturing apparatuses 290 as stored in a digital artifact 225 assigned to the fabric component in association with the associated one of the manufacturing apparatuses 290, which the program instructions store in the memory 220.

Thereafter, the program instructions message the associated one of the manufacturing apparatuses 290 with the parameter set 215. Subsequent to the processing of the fabric component, the associated one of the manufacturing apparatuses 290 return one or more observable data values reflecting performance data of the fabric component, the associated one of the manufacturing apparatuses 290, or both. Consequently, the program instructions access the process management API 280 with a directive to write the observable data values to the digital artifact 225 assigned to the fabric component in association with the associated one of the manufacturing apparatuses 290.

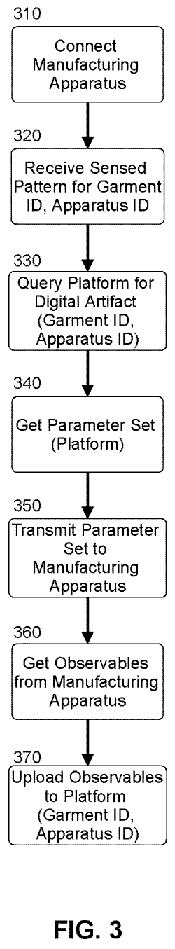

In further illustration of an exemplary operation of the module, FIG. 3 is a flow chart illustrating one of the aspects of the process of FIG. 1. Beginning in block 310, a communicatively coupling is established with a manufacturing apparatus and in block 320, a garment identifier is received for a fabric component loaded for processing the manufacturing apparatus, along with an identifier for the manufacturing apparatus. In block 330, a query is directed to a process management platform with the garment identifier and the apparatus identifier and in block 340, in response, a parameter set is received as extracted by the process management platform from a portion of a digital artifact associated with the garment identifier and the apparatus identifier.

In block 350, the parameter set is transmitted over the communicative coupling to the manufacturing apparatus in order to configure the manufacturing apparatus. Thereafter, in block 360 observable data is received from the manufacturing apparatus from over the communicative coupling in respect to performance data during the processing by the manufacturing apparatus of the fabric component. Consequently, in block 370 the observables are written to the digital artifact in association with the manufacturing apparatus by the process management platform.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A garment manufacturing data processing system adapted for unit of one manufacturing of a garment, the system comprising:
a manufacturing apparatus adapted to process fabric components of garments as part of a sequence of manufacturing apparatuses of a garment fabrication system which collectively fabricate the garments;
a host computing platform comprising one or more computers, each with memory and one or processing units including one or more processing cores;
a process management platform communicatively coupled to the host computing platform over a data communications network and providing an application programming interface (API) configured to receive through the API unique identifiers and return in response different sets of manufacturing parameters within correspondingly different digital artifacts, each for an associated one of the garments with the manufacturing parameters being specific to a specified one of the manufacturing apparatuses; and,
a configuration and performance module comprising computer program instructions enabled while executing in the memory of at least one of the processing units of the host computing platform to perform:
remotely sensing an identity of one of the fabric components of one of the garments at a selected one of the manufacturing apparatus;
retrieving a unique identifier for the remotely sensed identity;
transmitting a query to the process management platform with the unique identifier and an identity of the manufacturing apparatus, and receiving from the platform in response, one of the different sets of the manufacturing parameters within the corresponding one of the correspondingly different digital artifacts for the one of the garments that are specific to the manufacturing apparatus;
configuring the manufacturing apparatus with the manufacturing parameters of the one of the different sets of the manufacturing parameters and operating the manufacturing apparatus upon the one of the fabric components; and,
recording observed metrics of the operation of the manufacturing apparatus and the one of the fabric components and transmitting the observed metrics to the process management platform for use in augmenting the corresponding one of the correspondingly different digital artifacts.

2. The system of claim 1, wherein the manufacturing apparatuses includes an ink printer, laser cutter and sewing machine.

3. The system of claim 1, wherein the identity of the one of the fabric components is remotely sensed visually by comparing a captured visual image of the one of the fabric components to pre-stored imagery of the one of the fabric components as a substrate upon which the one of the fabric components has been printed is loaded into the manufacturing apparatus.

4. The system of claim 1, wherein the identity of the one of the fabric components is remotely sensed by reading a radio frequency identification (RFID) tag fixed to the one of the fabric components.

5. The system of claim 1, wherein the corresponding one of the correspondingly different digital artifacts is a singular aggregation of data defining physical and economic characteristics both of the one of the garments and also of a manufacturing lifecycle of the one of the garments across all of the manufacturing apparatuses to which the one of the garments is subjected.

6. A method for unit of one manufacturing of a garment comprising:
remote sensing an identity of a fabric component of a garment at a manufacturing apparatus of a garment manufacturing system;
retrieving a unique identifier for the remotely sensed identity;
transmitting a query to a process management platform with the unique identifier and receiving from the platform in response, a set of manufacturing parameters within a digital artifact for the garment that are specific to the manufacturing apparatus;
configuring the manufacturing apparatus with the manufacturing parameters and operating the manufacturing apparatus upon the fabric component; and,
recording observed metrics of the operation of the manufacturing apparatus and the fabric component and transmitting the observed metrics to the process management platform for use in augmenting the digital artifact.

7. The method of claim 6, wherein the manufacturing apparatus is selected from the group consisting of ink printer, laser cutter and sewing machine.

8. The method of claim 6, wherein the identity of the fabric component is remotely sensed visually by comparing a captured visual image of the fabric component to pre-stored imagery of the fabric component as a substrate upon which the fabric component has been printed is loaded into the manufacturing apparatus.

9. The method of claim 6, wherein the identity of the fabric component is remotely sensed by reading a radio frequency identification (RFID) tag fixed to the fabric component.

10. The method of claim 6, wherein the digital artifact is a singular aggregation of data defining physical and economic characteristics both of the garment and also of a manufacturing lifecycle of the garment across all apparatuses of the system to which the garment is subjected.

11. A computing device comprising a non-transitory computer readable storage medium having program instructions stored therein, the instructions being executable by at least one processing core of a processing unit to cause the processing unit to perform a method for unit of one manufacturing of a garment, the method including:
remote sensing an identity of a fabric component of a garment at a manufacturing apparatus of a garment manufacturing system;
retrieving a unique identifier for the remotely sensed identity;
transmitting a query to a process management platform with the unique identifier and receiving from the platform in response, a set of manufacturing parameters within a digital artifact for the garment that are specific to the manufacturing apparatus;
configuring the manufacturing apparatus with the manufacturing parameters and operating the manufacturing apparatus upon the fabric component; and,
recording observed metrics of the operation of the manufacturing apparatus and the fabric component and transmitting the observed metrics to the process management platform for use in augmenting the digital artifact.

12. The device of claim 11, wherein the manufacturing apparatus is selected from the group consisting of ink printer, laser cutter and sewing machine.

13. The device of claim 11, wherein the identity of the fabric component is remotely sensed visually by comparing a captured visual image of the fabric component to pre-stored imagery of the fabric component as a substrate upon which the fabric component has been printed is loaded into the manufacturing apparatus.

14. The device of claim 11, wherein the identity of the fabric component is remotely sensed by reading a radio frequency identification (RFID) tag fixed to the fabric component.

15. The device of claim 11, wherein the digital artifact is a singular aggregation of data defining physical and economic characteristics both of the garment and also of a manufacturing lifecycle of the garment across all apparatuses of the system to which the garment is subjected.
